(19) United States
(12) Patent Application Publication
(10) Pub. No.: US 2026/0139999 A1
(43) Pub. Date: May 21, 2026

(54) THERMISTOR SPACERS

(71) Applicant: GM Cruise Holdings, LLC, San Francisco, CA (US)

(72) Inventors: Daniel Beckmeier, San Francisco, CA (US); Howard Davidson, San Mateo, CA (US); Jie Liu, Pleasanton, CA (US); Fen Chen, Morgan Hill, CA (US)

(73) Assignee: GM Cruise Holdings, LLC, San Francisco, CA (US)

(21) Appl. No.: 19/330,637

(22) Filed: Sep. 16, 2025

Related U.S. Application Data
(60) Provisional application No. 63/723,438, filed on Nov. 21, 2024.

(51) Int. Cl. G01K 7/22; G01K 3/14; H01C 7/00; H01C 17/00

(52) U.S. Cl. CPC G01K 7/226; G01K 3/14; H01C 7/008; H01C 17/00

(57) ABSTRACT

A method includes forming a temperature measurement assembly comprising a plurality of thermally coupled layers of a first thermally conductive material, wherein an inner layer of the plurality of thermally coupled layers comprises one or more voids defined therein, wherein each void receives a thermistor secured in the void using a second thermally conductive material that thermally couples the thermistor to the inner layer. The method also includes positioning the temperature measurement assembly on and in thermal communication with a surface of a device, and measuring temperatures of the surface of the device using the thermistors.

### CROSS-REFERENCE TO RELATED APPLICATION

This application claims priority under 35 U.S.C. § 119(e) to U.S. Provisional Patent Application Ser. No. 63/723,438, filed Nov. 21, 2024. The disclosure of this prior application is considered part of the disclosure of this application and is hereby incorporated by reference in its entirety.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

A device's thermal resistance (Rth) represents how well the device resists the flow of heat through the device. The thermal resistance may be useful in, for example, characterizing the ability of a high-power artificial intelligence (AI) processor to operate in various environmental conditions. Knowing a processor's thermal resistance may be especially useful in vehicular applications where the processor may be exposed to a wide range of environmental conditions.

The present disclosure relates generally to thermistor spacers for use in measuring a processor's thermal resistance.

### SUMMARY

An aspect of the disclosure provides an assembly configured to measure a temperature of a surface of a device. The assembly includes a first sheet of a first thermally conductive material, a spacer of a second thermally conductive material, and a second sheet of a fourth thermally conductive material. The spacer includes one or more voids defined in the second thermally conductive material, one or more thermistors received in respective ones of the one or more voids, and a third thermally conductive material in the one or more voids to secure the one or more thermistors in the one or more voids and to thermally couple the one or more thermistors to the second thermally conductive material. The first sheet is affixed and thermally coupled to a first surface of the spacer, a second surface of the second sheet is affixed and thermally coupled to a third surface of the spacer, and a fourth surface of the second sheet is configured to be thermally coupled to the surface of the device.

Implementations of the disclosure may include one or more of the following optional features. In some implementations the first, second, and fourth thermally conductive materials are copper. In some examples, the third thermally conductive material is indium tin solder. In some implementations, the third thermally conductive material has a melting point that is less than a temperature limit of the one or more thermistors and greater than an expected maximum temperature of the surface of the device.

In some examples, the first sheet is affixed and thermally coupled to the first surface of the spacer using solder, and the second surface of the second sheet is affixed and thermally coupled to the third surface of the spacer using solder. In some implementations, a thickness of the spacer exceeds a diameter of the one or more thermistors.

In some implementations, the one or more thermistors are arranged to one of measure surface temperatures at different locations, provide redundancy, provide fault recovery, or measure a spatial thermal gradient. In some examples, the one or more voids include one or more of a groove, a channel, a slot, or a hole. In some implementations, the one or more thermistors are calibrated thermistors.

Another aspect of the disclosure provides a method including forming a first sheet of a first thermally conductive material, and forming a spacer of a second thermally conductive material, defining one or more voids in the second thermally conductive material, positioning one or more thermistors in respective ones of the one or more voids and applying a third thermally conductive material in the one or more voids to secure the one or more thermistors in the one or more voids and thermally couple the one or more thermistors to the second thermally conductive material. The method also includes forming a second sheet of a fourth thermally conductive material, affixing and thermally coupling the first sheet to a first surface of the spacer, and affixing and thermally coupling a second surface of the second sheet to a third surface of the spacer.

Implementations of the disclosure may include one or more of the following optional features. In some implementations, the first, second, and fourth thermally conductive materials are copper. In some examples, the third thermally conductive material is indium tin solder. In some implementations, the third thermally conductive material has a melting point that is less than a temperature limit of the one or more thermistors and greater than an expected maximum temperature of the surface of the device.

In some examples, the first sheet is affixed and thermally coupled to the first surface of the spacer using solder, and the second surface of the second sheet is affixed and thermally coupled to the third surface of the spacer using solder. In some implementations, a thickness of the spacer exceeds a diameter of the one or more thermistors.

In some implementations, the one or more thermistors are arranged to one of measure temperatures of the surface of the device at different locations, provide redundancy, provide fault recovery, or measure a spatial thermal gradient. In some examples, the one or more voids include one or more of a groove, a channel, a slot, or a hole. In some implementations, the one or more thermistors are calibrated thermistors.

Yet another aspect of the disclosure provides another method including forming a temperature measurement assembly including a plurality of thermally coupled layers of a first thermally conductive material, wherein an inner layer of the plurality of thermally coupled layers includes one or more voids defined therein, wherein each void receives a thermistor secured in the void using a second thermally conductive material that thermally couples the thermistor to the inner layer. The method also includes positioning the temperature measurement assembly on and in thermal communication with a surface of a device, and measuring temperatures of the surface of the device using the thermistors.

Implementations of the disclosure may include one or more of the following optional features. In some implementations, the first thermally conductive material is copper, the plurality of thermally coupled layers are coupled using solder, and the second thermally conductive material is indium tin solder having a melting point that is less than a temperature limit of the one or more thermistors and that is greater than an expected maximum temperature of the surface of the device. In some examples, a thickness of the inner layer exceeds a diameter of the one or more thermistors. In some examples, the one or more thermistors are arranged to one of measure temperatures of the surface of the device at different locations, provide redundancy in measuring temperatures of the surface of the device, or measure a spatial thermal gradient.

### BRIEF DESCRIPTION OF THE DRAWINGS

The drawings described herein are for illustrative purposes only of selected configurations and are not intended to limit the scope of the present disclosure.

FIG. 1 is a view of an example thermal resistance measurement system having a thermistor spacer in accordance with principles of the present disclosure.

FIG. 2 is a side view of the thermistor spacer of FIG. 1.

FIG. 3 is a top view of a spacer layer of the thermistor spacer of FIG. 2.

FIG. 4 is a flowchart of an example arrangement of operations for forming a thermistor spacer in accordance with principles of the present disclosure.

FIG. 5 is a flowchart of an example arrangement of operations for using a thermistor spacer in accordance with principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A device's thermal resistance (Rth) represents how well the device resists the flow of heat through the device. The thermal resistance may be useful in, for example, characterizing the ability of a high-power artificial intelligence (AI) processor to operate in various environmental conditions. Knowing a processor's thermal resistance may be especially useful in vehicular applications where the processor may be exposed to a wide range of environmental conditions. A processor having a high-power dissipation (e.g., 300-to-400 Watts) may make even small changes in thermal resistance result in significant changes to the processor's temperature, especially in harsh operating environments, such as those associated with vehicles. In some circumstances, a processor's high temperature may impact its ability to perform autonomous operations or an advanced driver-assistance system (ADAS) for a vehicle. Therefore, there is a need for accurately measuring a device's thermal resistance.

The present disclosure relates generally to thermistor spacers for use in measuring a device's thermal resistance. Disclosed thermistor spacers enable precise measurements of surface temperatures (e.g., within 0.2° C.), can operate with cooling systems that cool the top of a device, provide a high thermal conductivity interface, are mechanically robust to allow reuse across multiple devices, and have a wide operating range (e.g., between −40° C. and 125° C.).

While configurations are shown and described herein in connection with a thermistor spacer for measuring the thermal resistance of a high-power AI processor for a vehicle (e.g., an automobile, a truck, an airplane, a train, a motorcycle, etc.), it should be understood that disclosed thermistor spaces may additionally, or alternatively, be used for measuring the thermal resistance of any type of processor or device used in any number and/or type(s) of applications.

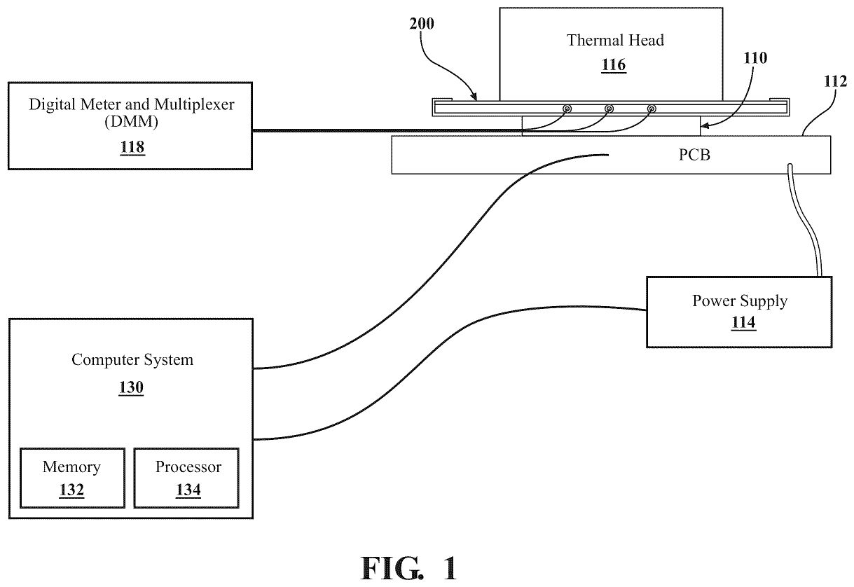

With particular reference to FIGS. 1, 2, and 3, a thermal resistance measurement system 100 is shown in conjunction with a thermistor spacer 200 in accordance with principles of the present disclosure. The thermal resistance measurement system 100 is configured to accurately measure surface temperature(s) of a device-under-test (DUT) 110. In the illustrated example, the DUT 110 is a high-power AI processor for performing autonomous operations or an ADAS for a vehicle (not shown for clarity of illustration). The DUT 110 is mounted to a printed circuit board (PCB) 112 that is configured to operate the DUT 110 during testing of the DUT 110. A power supply 114 provides power for the PCB 112.

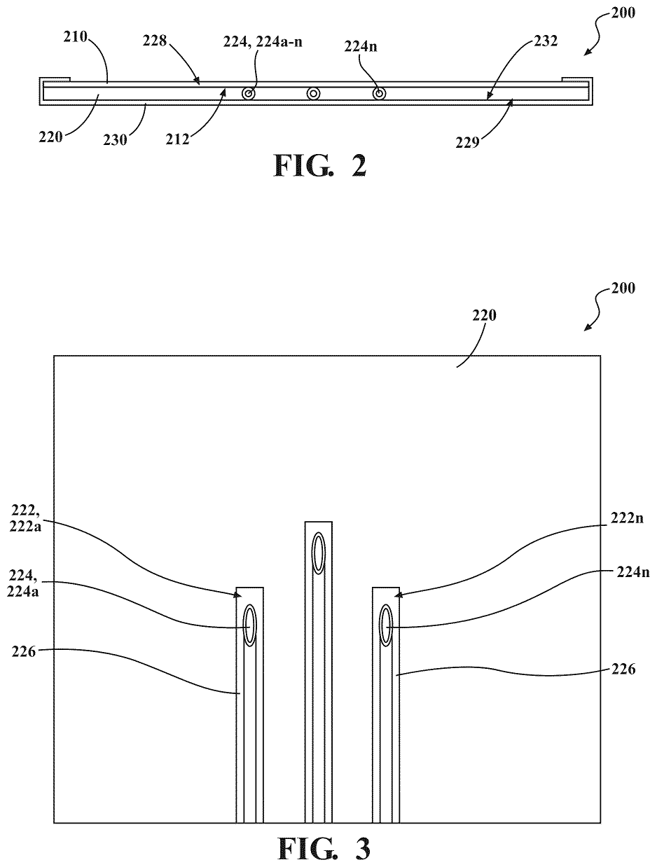

Referring to FIGS. 2 and 3, the thermistor spacer 200 includes multiple thermally coupled layers. In the illustrated example, the thermistor spacer 200 includes a top layer or sheet 210, an inner or spacer layer or sheet 220, and a bottom layer or sheet 230. The layers 210, 220, and 230 are each formed of a thermally conductive material. In some implementations, the layers 210, 220, and 230 are formed of the same thermally conductive material. In some examples, the thermally conductive material is copper or a copper alloy.

The inner or spacer layer 220 includes one or more voids 222, 222a-n defined in the thermally conductive material of the inner or spacer layer 220, and one or more thermistors 224, 224a-n received in respective ones of the one or more void(s) 222. In some examples, the void(s) 222 are grooves, channels, slots, holes, etc. defined or formed in the thermally conductive material of the inner or spacer layer 220 that are shaped and dimensioned to receive the thermistor(s) 224. In the illustrated example, the thermistor(s) 224 are secured in the void(s) 222 using a thermally conductive material 226 that thermally couples the thermistor(s) 224 to the inner or spacer layer 220 and fills the voids 224. An example thermally conductive material 226 is solder, such as indium tin solder (e.g., IN52/SN48 solder). In some implementations, the solder 226 is selected to have a melting point that is less than a temperature limit of the one or more thermistor(s) 224 and greater than an expected maximum temperature of the surface of the DUT 110. Here, the thickness of the inner or spacer layer 220 and a dimension (e.g., a diameter) of the thermistor(s) 224 are selected so that the thermistor(s) 224 are not damaged if or when compression force is applied to the thermistor spacer 200.

In some implementations, the void(s) 222 are arranged to, for example, measure temperatures of the surface of the DUT 110 at different locations (e.g., different locations of interest), provide redundancy, provide fault recovery, measure a spatial thermal gradient on the surface of the DUT 110. In some examples, the thermistor(s) 224 are calibrated thermistors or uncalibrated thermistors that are calibrated.

In some implementations, the layers 210, 220 and 230 are affixed together and thermally coupled using a thermally conductive material, such as a solder (not shown for clarity of illustration). An example solder includes indium tin solder (e.g., IN52/SN48 solder). The solder used to thermally couple the layers 210, 220, and 230 may be different from the thermally conductive material 226 used to secure the thermistor(s) 224 in the voids 222. In particular, a bottom surface 212 of the top layer 210 is affixed and thermally coupled to a top surface 228 of the inner or spacer layer 220 using solder, and a top surface 232 of the bottom layer 230 is affixed and thermally coupled to a bottom surface 229 of the inner or spacer layer 220 using solder.

As shown in the illustrated example, the bottom layer 230 may be wrapped around the upper layer 210 and the inner layer 220 to additionally secured the layers 210, 220, and 230 together.

Returning to FIG. 1, the thermal resistance measurement system 100 also includes a thermal head 116 and a digital meter and multiplexer (DMM) 118. The DMM 118 is electrically connected to the thermistor(s) 224 for measuring temperatures on one or more locations on a surface of the DUT 110. The measurements taken by the DMM 118 may be processed by a computer system 130 for processing the measurements to, for example, determine a thermal resistance (Rth) of the DUT 110. Specifically, the computer system 130 stores machine-readable instructions for executing on, for example, memory hardware 132. The instructions may be executed by data processing hardware 134 (e.g., a processor) of the computer system 130 to determine the thermal resistance (Rth) of the DUT 110.

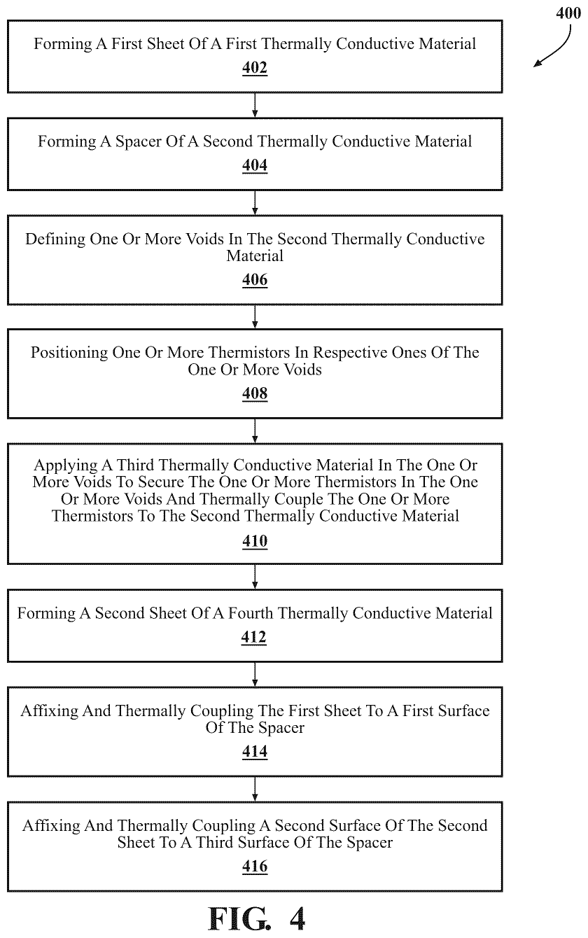

FIG. 4 is a flowchart of an example arrangement of operations for forming a thermistor spacer (e.g., the thermistor spacer 200) in accordance with principles of the present disclosure. Many other ways of implementing the method 400 may be employed. For example, the order of execution of the operations may be changed, and/or one or more of the operations and/or interactions may be changed, eliminated, sub-divided, or combined. Additionally, the operations of FIG. 4 may be carried out sequentially and/or in parallel.

At operation 402, the method 400 includes forming a first sheet 210 of a first thermally conductive material. At operation 404, the method 400 includes forming a spacer 220 of a second thermally conductive material. At operation 406, the method 400 includes defining or forming one or more voids 222 in the second thermally conductive material. At operation 408, the method 400 includes positioning one or more thermistors 224 in respective ones of the one or more voids 222. At operation 410, the method 400 includes applying a third thermally conductive material 226 in the one or more voids 222 to secure the one or more thermistors 224 in the one or more voids 222 and thermally couple the one or more thermistors 224 to the second thermally conductive material. At operation 412, the method 400 includes forming a second sheet 230 of a fourth thermally conductive material. At operation 416, the method 400 includes affixing and thermally coupling the first sheet 210 to a first surface 228 of the spacer 220. At operation 418, the method includes affixing and thermally coupling a second surface 232 of the second sheet 220 to a third surface 229 of the spacer 220.

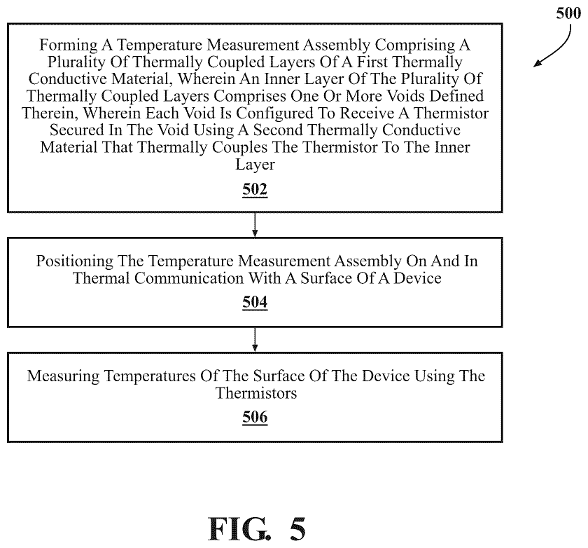

FIG. 5 is a flowchart of an example arrangement of operations for using a thermistor spacer (e.g., the thermistor spacer 200) in accordance with principles of the present disclosure. The operations may be performed by data processing hardware (e.g., the processor 134) based on executing instructions stored on memory (e.g., the memory hardware 132). Many other ways of implementing the method 500 may be employed. For example, the order of execution of the operations may be changed, and/or one or more of the operations and/or interactions may be changed, eliminated, sub-divided, or combined. Additionally, the operations of FIG. 5 may be carried out sequentially and/or in parallel by, for example, separate processing threads, processors, devices, discrete logic, circuits, etc.

At operation 502, the method 500 includes forming a temperature measurement assembly 200 comprising a plurality of thermally coupled layers 210, 220, 230 of a first thermally conductive material, wherein an inner layer 220 of the plurality of thermally coupled layers 210, 220, 230 comprises one or more voids 222 defined therein, wherein each void 222 is configure to receive a thermistor 224 secured in the void 222 using a second thermally conductive material 226 that thermally couples the thermistor 224 to the inner layer 220. At operation 504, the method 500 includes positioning the temperature measurement assembly 200 on and in thermal communication with a surface of a DUT 110. At operation 506, the method 500 includes measuring temperatures of the surface of the DUT 110 using the thermistors 224.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An assembly configured to measure a temperature of a surface of a device, the assembly comprising:
a first sheet comprising a first thermally conductive material;
a spacer comprising:
a second thermally conductive material;
one or more voids defined in the second thermally conductive material;
one or more thermistors received in respective ones of the one or more voids; and
a third thermally conductive material in the one or more voids to secure the one or more thermistors in the one or more voids and to thermally couple the one or more thermistors to the second thermally conductive material; and
a second sheet comprising a fourth thermally conductive material,
wherein the first sheet is affixed and thermally coupled to a first surface of the spacer,
wherein a second surface of the second sheet is affixed and thermally coupled to a third surface of the spacer, and
wherein a fourth surface of the second sheet is configured to be thermally coupled to the surface of the device.

2. The assembly of claim 1, wherein the first, second, and fourth thermally conductive materials comprise copper.

3. The assembly of claim 2, wherein the third thermally conductive material comprises indium tin solder.

4. The assembly of claim 1, wherein the third thermally conductive material comprises a melting point that is less than a temperature limit of the one or more thermistors and greater than an expected maximum temperature of the surface of the device.

5. The assembly of claim 1, wherein:
the first sheet is affixed and thermally coupled to the first surface of the spacer using solder; and
the second surface of the second sheet is affixed and thermally coupled to the third surface of the spacer using solder.

6. The assembly of claim 1, wherein a thickness of the spacer exceeds a diameter of the one or more thermistors.

7. The assembly of claim 1, wherein the one or more thermistors are arranged to one of:
measure temperatures of the surface of the device at different locations;
provide redundancy;
provide fault recovery; or
measure a spatial thermal gradient.

8. The assembly of claim 1, wherein the one or more voids comprise one or more of a groove, a channel, a slot, or a hole.

9. The assembly of claim 1, wherein the one or more thermistors comprise calibrated thermistors.

10. A method comprising:
forming a first sheet of a first thermally conductive material;
forming a spacer of a second thermally conductive material;
defining one or more voids in the second thermally conductive material;
positioning one or more thermistors in respective ones of the one or more voids; and
applying a third thermally conductive material in the one or more voids to secure the one or more thermistors in the one or more voids and thermally couple the one or more thermistors to the second thermally conductive material;
forming a second sheet of a fourth thermally conductive material;
affixing and thermally coupling the first sheet to a first surface of the spacer; and
affixing and thermally coupling a second surface of the second sheet to a third surface of the spacer.

11. The method of claim 10, wherein:
the first, second, and fourth thermally conductive materials comprise copper; and
the third thermally conductive material comprises indium tin solder.

12. The method of claim 10, wherein the third thermally conductive material comprises a melting point that is less than a temperature limit of the one or more thermistors and greater than an expected maximum temperature that the third thermally conductive material will be exposed to during use.

13. The method of claim 12, wherein:
the first sheet is affixed and thermally coupled to the first surface of the spacer using solder; and
the second surface of the second sheet is affixed and thermally coupled to the third surface of the spacer using solder.

14. The method of claim 10, wherein a thickness of the spacer exceeds a diameter of the one or more thermistors.

15. The method of claim 10, wherein the one or more thermistors are arranged to one of:
measure surface temperatures at different locations;
provide redundancy;
provide fault recovery; or
measure a spatial thermal gradient.

16. The method of claim 10, wherein the one or more thermistors comprise calibrated thermistors.

17. A method comprising:
forming a temperature measurement assembly comprising a plurality of thermally coupled layers of a first thermally conductive material, wherein an inner layer of the plurality of thermally coupled layers comprises one or more voids defined therein, wherein each void receives a thermistor secured in the void using a second thermally conductive material that thermally couples the thermistor to the inner layer;
positioning the temperature measurement assembly on and in thermal communication with a surface of a device; and
measuring temperatures of the surface of the device using the thermistors.

18. The method of claim 17, wherein:
the first thermally conductive material comprises copper;
the plurality of thermally coupled layers are coupled using solder; and
the second thermally conductive material comprises indium tin solder having a melting point that is less than a temperature limit of the one or more thermistors and that is greater than an expected maximum temperature of the surface of the device.

19. The method of claim 17, wherein a thickness of the inner layer exceeds a diameter of the one or more thermistors.

20. The method of claim 17, wherein the one or more thermistors are arranged to one of:
measure temperatures of the surface of the device at different locations;
provide redundancy in measuring temperatures of the surface of the device; or
measure a spatial thermal gradient.
